(19) United States
(12) Patent Application Publication
(10) Pub. No.: US 2020/0291576 A1
(43) Pub. Date: Sep. 17, 2020

(54) PRESS COVER, AND PROCESS FOR PRODUCTION OF SUCH A PRESS COVER

(71) Applicant: VOITH PATENT GMBH, Heidenheim (DE)

(72) Inventor: DELPHINE DELMAS, Heidenheim (DE)

(73) Assignee: Voith Patent GmbH, Heidenheim (DE)

(21) Appl. No.: 16/628,757

(22) PCT Filed: Jun. 13, 2018
(86) PCT No.: PCT/EP2018/065577

§ 371 Date: Jan. 6, 2020

(30) Foreign Application Priority Data
Jul. 6, 2017 (DE) 10 2017 115 084

(51) Int. Cl. D21F 3/08; B30B 3/00; B30B 3/04; D21F 3/04

(52) U.S. Cl. CPC D21F 3/08; D21F 3/04; B30B 3/04; B30B 3/005

(57) ABSTRACT

A press cover has at least one polymer layer. The polymer layer includes, or is produced from, a polyurethane. The polyurethane has been formed from a prepolymer and a crosslinker. The prepolymer is a reaction product of phenylene 1,4-diisocyanate and at least one polyol. The crosslinker includes at least two components, namely, a first component having at least one diamine and a second component from the group of the carbonic esters.

The invention proceeds from a press cover, especially for a press apparatus for treatment of a fibrous material layer, for example for smoothing or dewatering thereof, and from a corresponding process for producing such a press cover, with specifics according to the independent claims.

Press apparatuses such as shoe presses have long been part of modern papermaking machines. They essentially comprise a shoe in a stationary arrangement (also called press shoe) that extends in a machine cross direction, and a circumferential press cover around the stationary shoe. The press cover is deformable and takes on essentially a tubular shape in operation. The shoe is formed such that it forms a press nip (press gap) with an opposing roll. The press nip is defined by the contact area of the opposing roll in the shoe. The shoe is designed to be movable and can be moved against the opposing roll.

Enormous demands are placed on the press cover in relation to its stability, namely with regard to surface hardness, and resistance to pressure, temperature and hydrolysis. The press cover is additionally exposed to significant flexural cycling stresses during operation. On arrival at the edge of the shoe—upstream of the press nip viewed in rotation direction of the press cover—there is initially flexion with a comparatively small radius. This immediately becomes an opposing flexion on passage through the press nip. On exit at the other edge of the shoe, i.e. downstream of the press nip viewed in rotation direction of the press cover, there is again an opposing flexion. This deformation of the press cover on entry and exit is also referred to as cycling nip. It is readily apparent that the tendency of the press cover to break particularly at this point is very high by virtue of the high mechanical stress. Correspondingly, there are many known measures from the prior art that are intended to increase the stability of the press cover.

In the materials sector, modern polymers, for example polyurethanes, are increasingly being used for press covers. By virtue of a suitable composition, these allow the production of press covers with high flexibility together with high stability.

However, existing polyurethanes known from the art have not been capable today of achieving stability and lifetime that are satisfactory to the customer in every case of use. These materials also have disadvantages in the production of the press covers. Firstly, the adjustment of the viscosity of the reaction mixture of prepolymer and crosslinker was problematic. If thicker individual layers per coating pass of the polymer layer were hitherto desired, this was not possible. Instead, a second coating pass had to be effected. Secondly, there were often trapped air bubbles as soon as the reinforcing structure, for example in the form of filaments, was cast with the material. Such air bubbles can form even in layers without reinforcing structure. A problem with air bubbles is that they often lead to premature failure of the press cover in operation.

Press covers of the generic type have become known from US 2015/0308044 A1 and EP 0048944 A1.

The present invention relates to such articles of the generic type that have been specified at the outset.

It is accordingly an object of the invention to specify a press cover and a process for production thereof that avoids the disadvantages of the prior art. A particular object is that of specifying a press cover having elevated stability and lifetime compared to the press covers known from the prior art.

The object is achieved by the features of the independent claims. Particularly preferred and advantageous embodiments of the invention are given in the dependent claims.

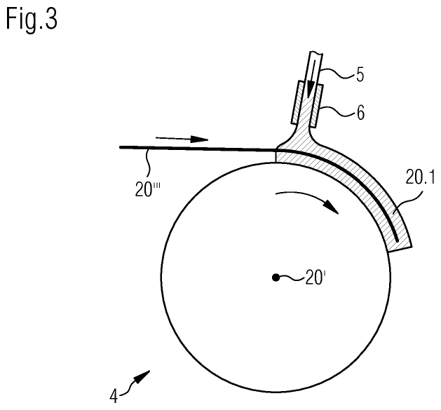

The inventor has recognized that the object of the invention can be achieved by the use of a crosslinker comprising a diamine and a carbonic ester, such as propylene carbonate or ethylene carbonate. The addition of a carbonic ester to the crosslinker in the production of a polyurethane-containing press cover, particularly by the process described in FIG. 3, is extremely unusual. This is because it is usual to use this as solvent in the plastics industry for purposes outside polyurethane production. It has been found that, surprisingly, the prepolymer/crosslinker mixture had a lower viscosity with simultaneously optimal pot life. It is thus possible for the resultant polymer of initially low viscosity to particularly efficiently impregnate the reinforcing structure (for example composed of filaments) before it solidifies as a result of the curing. It is also possible for particularly rough substrates to be wetted. In both cases, air bubbles can escape very efficiently within the time. According to the invention, it is therefore possible to produce virtually bubble-free press covers by means of rotary casting that enable polymer layers of thickness up to 40 mm—which are producible in one coating pass, i.e. in a monolithic manner.

Particularly in interplay with PPDI as isocyanate, an additional outcome is very advantageous mechanical properties, such as dynamic properties of the press cover, low swelling and excellent stability to hydrolysis.

If, in the present invention, reference is made to an isocyanate, this means a polyisocyanate such as diisocyanate.

In the context of the invention, a press apparatus means, for example, a shoe press, for example for dewatering or treatment, such as smoothing, of a fibrous material web. The shoe press comprises a shoe press roll and an opposing roll that together form or bound a press nip. The shoe press roll further comprises a circumferential press cover and a fixed press element, called the press shoe. The latter rests on a supporting, likewise stationary yoke—for example via hydraulic press elements—and is pressed onto the circumferential press cover. The press cover revolves relative to the fixed press shoe and yoke and is thus pressed onto the opposing roll in the press nip. Press shoe and yoke are arranged radially within the press cover. The term “fixed” is understood to mean that the press element does not revolve relative to the shoe press roll or the opposing roll, but can move in a translational manner—toward and away from the opposing roll, preferably in radial direction thereof—and hence relative to the opposing roll. In addition to the fibrous material web and the press cover, it is possible for one or more continuously circumferential press felts and/or further continuously circumferential press belts to be guided through the press nip of the shoe press. Such a shoe press may of course comprise more than one press nip.

A fibrous material web in the context of the invention is understood to mean a laid scrim or unstructured tangle of fibers, such as wood fibers, plastic fibers, glass fibers, carbon fibers, additions, additives or the like. For example, the fibrous material web may take the form of a paper, cardboard or tissue web. It may essentially comprise wood fibers, where small amounts of other fibers or else additions and additives may be present. This is a matter for the person skilled in the art according to the individual use.

A press cover in the context of the invention is understood to mean a belt, hose or cover which, as described, is guided together with a fibrous material web through the press nip of a shoe press. The fibrous material web can be dewatered in operation as intended by contacting the radially outermost surface (polymer layer) of the press cover with a press felt that directly bears the fibrous material web to be dewatered. According to the embodiment of the press device, for example for smoothing thereof, the press cover in operation as intended may also come into direct contact with the fibrous material web. The press cover is in the form here of a continuous cover (hose) which is endless in circumferential direction about its longitudinal axis. At its axial ends—viewed in breadth direction (along the longitudinal axis)—it is open. It is thus possible for the press cover to be held by two lateral tension plates at its axial ends, in order to form the shoe press roll. Rather than being guided by the two lateral tension plates, the press cover, as is the case for open shoe presses, may be guided over the press shoe and multiple guide rolls. Irrespective of whether the press cover is guided by the tension plates or the guide rolls, the press shoe (or the guide rolls) come(s) (intermittently) into contact with part of the radially innermost surface of the press cover. The radially outermost surface of such a press cover, i.e., for example, the radially outermost polymer layer thereof, may have been provided with grooves and/or blind holes.

The press cover may have been partly or completely manufactured from a polymer. The polymer used may be a castable, curable, preferably elastomeric, polymer such as polyurethane. The polymer may consequently be formulated as a cast elastomer.

“Polymer layer” means a layer that comprises or has been produced entirely from such a castable, curable, preferably elastomeric, polymer. The polymer layer may preferably be a cured layer that has been produced in one piece by primary shaping. In other words, it has been made by primary shaping in monolithic form, i.e., for example, by casting. The term “one-piece” also includes cases in which one layer has in turn been produced from multiple strata of the same material in the casting of the polymer. However, this is only true if these strata are essentially no longer visible after the curing, and the result is instead a single, preferably uniform layer. The same is correspondingly true of the finished press cover.

In the case of provision of multiple polymer layers, these may be arranged one on top of another viewed in radial direction—at least in sections over the width of the press cover. “At least in sections over the width of the press cover” means that the press cover has only a single layer, for example at its axial ends, whereas it is in two-layer or multilayer form between the axial ends. However, the polymer layers may also extend over the entire width of the press cover. It is also possible for the thickness of the press cover—and hence the thickness of the individual polymer layers—to vary in sections over the longitudinal axis in a section through the longitudinal axis thereof. For example, the radially outermost polymer layer in the region of the widthwise edges of the press cover may be lower than in the middle of the press cover. In other words, in the region of the widthwise edges, the radially outermost polymer layer may be less thick than a radially inner or radially innermost polymer layer. Preferably, exactly one, two or three polymer layer(s) is/are provided. These may be in identical form in terms of their polymer or may vary in terms of their hardness or stoichiometry of the prepolymer. A total thickness of the finished press cover in a section through the longitudinal axis thereof, measured in radial direction, may be 5 to 10 mm, preferably 5 to 7, more preferably 5 to 6 mm. According to the invention, in the case of provision of a single layer, the press cover may have been manufactured from just one casting, i.e. in monolithic form, such that the single layer has the thickness just mentioned.

A finished press cover in the context of the invention is one wherein the at least one polymer layer has been cured and finally processed, i.e. is ready for use for the purpose stated at the outset, in a shoe press for example. Analogously, “finished polymer layer” means a layer that has been cured.

In principle, it is conceivable that the press cover has a reinforcing structure. The term “reinforcing structure” in the context of the invention means a reinforcement of the at least one layer containing or consisting of the polymer—i.e. the polymer layer. The reinforcing structure may be entirely embedded here into the polymer layer, such that the reinforcing structure does not extend beyond the boundary of the polymer layer. In other words, the polymer layer assumes the role of a matrix that surrounds the reinforcing structure and binds to the matrix as a result of adhesion or cohesion forces. Such a reinforcing structure may include reinforcing structures such as textile linear structures—e.g. yarns or twines—and/or textile fabrics—for example woven fabrics, loop-formed knitted fabrics, loop-drawn knitted fabrics, braids or scrims—and may be producible from a corresponding starting material, for example by winding. “Starting material” is understood to mean that material or semifinished product by means of which the reinforcing structure of the finished press cover of the invention is produced. According to the process of the invention, such a reinforcing structure may be embedded into the polymer layer in or after step e). The starting material thus forms, after embedding into the corresponding polymer layer, the reinforcing structure of the finished press cover of the invention.

Where it is said in the context of the invention that the crosslinker comprises at least two components, this is understood to mean working examples comprising exactly two, exactly three, exactly four or exactly five or more than five components. According to the invention, the crosslinker is to have been produced from at least two components. The percentages of the two, three, four, five or more components may of course have been chosen such that exactly two, three, four, five or more components are present. The percentages of each of the at least two components of the crosslinker may be chosen such that they do not extend beyond 100% by weight in their totality.

In principle, it would be conceivable that the crosslinker includes a third component (K3) selected from at least one polyol, preferably bifunctional polyol, having a molecular weight of preferably 1000 to 4000 g/mol, such as polyester polyol, especially polycaprolactone polyol; polyether polyols, especially polytetramethylene ether glycol (PTMEG), polypropylene glycol (PPG), polyethylene glycol (PEG), polyhexamethylene ether glycol, polycarbonate polyol, polyether carbonate polyol, polybutadiene polyol, perfluoropolyether polyol, silicone polyol or mixtures thereof.

It would also alternatively be conceivable that, in addition to the three components just mentioned, there is also a fourth component (K4) that comprises or is formed by a catalyst, where the fourth component (K4) is selected from tertiary amines, such as 1,4-diazabicyclo(2.2.2)octane (DABCO), triethylamine, metal compounds, organometallic compounds—for example comprising or containing bismuth, such as bismuth neodecanoate, mercury, aluminum, zirconium, iron, calcium, sodium, potassium, lead, tin, titanium—or mixtures of the aforementioned substances. By means of a catalyst, it is possible in principle to better control the reaction rate of the crosslinking—and hence of the process for production of the press cover—when one is mixed into the crosslinker. According to the invention, the addition of the active molecules bearing hydrogen atoms can reduce the proportion of the catalyst. It would therefore be conceivable in principle to dispense with component K4, i.e. the catalyst.

Nevertheless, particularly good results that achieve the advantages cited at the outset in a more than satisfactory manner arise when the crosslinker contains 0.01 mol % to 5 mol % of the fourth component (K4).

The statements already made with regard to exactly two components are analogously applicable here too: the percentages of each of the exactly three, four or exactly five components can be chosen such that they do not go beyond 100% by weight in their totality. In other words, this means that exactly three or exactly four or exactly five components are present in the crosslinker.

Irrespective of the alternatives mentioned, i.e., for example, whether the crosslinker has been produced from or comprises exactly two, three, exactly four or exactly five or more components, each of the components mentioned could in turn consist of further sub-components. Preferably, however, the substances of the invention are themselves the components.

If “at least” one component of the crosslinker is referred to according to the invention, this means either exactly one or more than one such component, i.e. multiple corresponding components.

The components of the invention may be added to the crosslinker, for example as per the process of the invention, before they are reacted with the prepolymer.

The term “not more than” with respect to a particular percentage of a component means that the proportion is at least >0%, i.e., for example, 0.01% or more, but not more than the particular percentage. In the case, for example, of “not more than 15%”, this always means the interval between >0%, i.e., for example, greater than 0.01%, and (exactly) 15%. Thus, in each case, all three, four, five or more components according to the invention are always and individually represented in the crosslinker. On the other hand, when it is said that “at least” 20%, for example, of a component is present, this means 20% or more, i.e. up to 100% of the component. The terms mentioned should be supplemented by the corresponding molar unit or weight unit.

When reference is made to aliphatic amines in the context of the invention, this may mean primary aliphatic amines, secondary aliphatic amines or tertiary aliphatic amines. In a preferred embodiment, however, the aliphatic amines are primary aliphatic amines since the advantages of the invention are best achieved therewith. This is analogously applicable to aromatic amines and to (aromatic) diamines.

Preferably, the polyol in the prepolymer may be selected from: polyester polyol, especially polycaprolactone polyol, polyether polyol, especially polytetramethylene ether glycol (PTMEG), polypropylene glycol (PPG), polyethylene glycol (PEG) or polyhexamethylene ether glycol; polycarbonate polyol, polyether carbonate polyol, polybutadiene polyol or mixtures thereof. In this way, it is possible to improve the mechanical and dynamic properties of the press cover of the invention, in addition to its good producibility.

The inventor has found that a press cover comprising at least one polymer layer, where the polymer layer contains or has been produced from a polyurethane, shows the advantages of the invention to a surprising degree if it is configured as follows:
the polyurethane is formed from a prepolymer and a crosslinker, and the prepolymer is a reaction product of phenylene 1,4-diisocyanate (PPDI) and a polyol, where the crosslinker comprises exactly four components, as follows:
a first component (K1) comprising 25% to 95% by weight of MCDEA as diamine
a second component (K2) comprising 1% to 25% by weight of propylene carbonate from the group of the carbonic esters, and
a third component (K3) comprising not more than 65% by weight of at least one polyol.

The invention also relates to a press roll, such as shoe press roll, for a shoe press for dewatering of a fibrous material web, wherein the press roll includes at least one press cover of the invention.

The invention also relates to a shoe press for dewatering of a fibrous material web, preferably a paper, cardboard, tissue or pulp web, comprising a press roll and an opposing roll that together form or bound a nip, wherein the press roll comprises a circumferential press cover, wherein the press cover takes the form according to the invention.

The invention finally relates to the use of a press cover of the invention for a press, such as shoe press for dewatering of a fibrous material web, preferably a paper, cardboard, tissue or pulp web.

The invention is elucidated in detail hereinafter with reference to the drawings without restriction of generality. The drawings show:

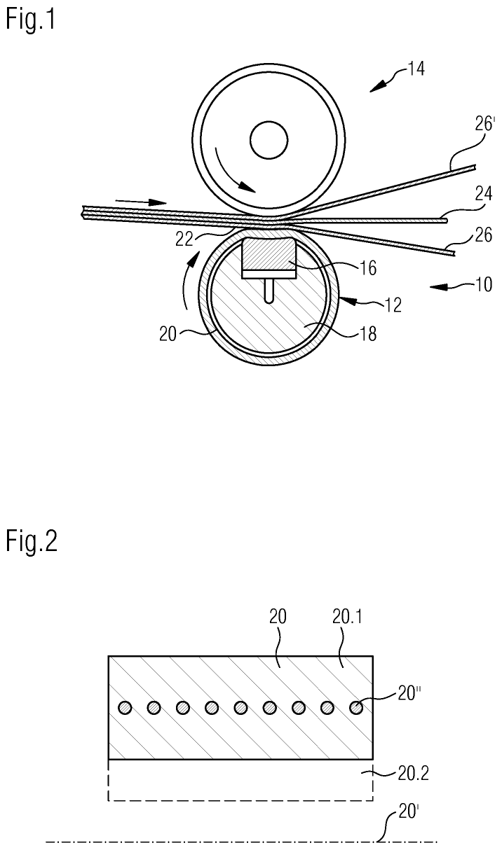

FIG. 1 a schematic side view as a partial section of a shoe press with a press cover in a working example of the present invention.

FIG. 2 a schematic diagram as an enlarged partial section of a working example of a press cover in a cross section through its longitudinal axis;

FIG. 3 a highly schematic diagram of the execution of the process of the invention in a side view of an apparatus for production of the press cover.

FIG. 1 shows a shoe press 10 which, in the present context, comprises a press roll of the invention, such as a shoe press roll 12, and an opposing roll 14. Shoe press roll 12 and opposing roll 14 are arranged parallel to one another with regard to their longitudinal axes. Together, they form or bound a nip 22.

While the opposing roll 14 here consists of a roll of cylindrical configuration that rotates about its longitudinal axis, the shoe press roll 12 is composed of a shoe 16, a stationary yoke 18 that bears it, and a press cover 20. Shoe 16 and yoke 18 are in a fixed arrangement in relation to the opposing roll 14 or the press cover 20. This means that they do not rotate. The shoe 16 is supported here by the yoke 18 and pressed onto the radially innermost surface of the press cover 20 that revolves relative thereto via hydraulic press elements (not shown). The press cover 20 that surrounds shoe 16 and yoke 18 in circumferential direction rotates here about its longitudinal axis in the opposite sense from the opposing roll 14. Owing to the concave configuration of the shoe 16 on its side facing the opposing roll 14, the result is a comparatively long nip 22.

The shoe press 10 is especially suitable for dewatering of fibrous material webs 24. In the operation of the shoe press, a fibrous material web 24 is guided through the press gap 22 with one or two press felts 26, 26′. In the present case, there are exactly two press felts 26, 26′ that accept the fibrous material web 24 between them in a sandwich-like manner. In the course of passage through the nip 22, the press felts 26, 26′ exert a pressure indirectly on the fibrous material web 24 in the nip 22. This is accomplished in that the radially outermost surface of the opposing roll 14 on the one hand and the radially outermost surface of the press cover 20 come into direct contact with the corresponding press felts 26, 26′. The liquid exiting from the fibrous material web 24 is temporarily absorbed by the press felt(s) 26, 26′ and any recesses provided in the press cover surface (not shown). After leaving the nip 22, the liquid absorbed by the depressions of the press cover 22 is spun off before the press cover 20 enters the press gap 22 again. In addition, the water absorbed by the press felt 26, 26′ can be removed by suction elements after departure from the press gap 22.

FIG. 2 shows one possible embodiment of the invention in a cross section along the longitudinal axis 20′ of the finished press cover 20 which is shown in part and not to scale. What can be seen is the (exactly) one polymer layer 20.1 of the press cover 20. As indicated by the dotted lines, it would be conceivable that the press cover 20 consists of multiple polymer layers arranged radially one on top of another. For example, exactly two polymer layers would be conceivable: a radially inner polymer layer (shown by dotted lines) 20.2 and a radially outermost polymer layer (shown by solid lines) 20.1. The multiple polymer layers could then be produced in accordance with the invention.

In the present case, a reinforcing structure 20″ has been embedded into the at least one polymer layer 20.1. This is indicated by the hatched circles that may be textile fabrics or linear structures such as fibers. The reinforcing structure 20″ has been completely embedded into the polymer layer 20.1. This means that the reinforcing structure 20″ does not extend beyond the boundaries of the polymer layer 20.1 into which it has been embedded.

FIG. 3 shows, in a highly schematic side view, an apparatus for production of a press cover 20 of the invention. The apparatus is set up to execute the process of the invention for producing the press cover 20. The apparatus in the present context has exactly one cylindrical winding mandrel 4, with application here, for example, of a reinforcing structure 20″ of a starting material 20′″ in spiral form to the radially outermost cover surface thereof.

The diagram shows an initial stage of the production process. In the present case, for this purpose, one end of the starting material 20′″ has been secured to a polymer disposed at the outer extent of the winding mandrel 4. Apart from the schematic diagram shown, it would also be possible for one end of the starting material 20′″ to lie on or have been applied to the winding mandrel 4, i.e. directly, without initial provision of a polymer between starting material 20′″ and winding mandrel 4. The starting material 20′″ here may be a textile fabric or linear structure.

The winding mandrel 4 is mounted so as to be rotatable about its longitudinal axis 20′, which corresponds to the longitudinal axis of the press cover to be produced. Longitudinal axis 20′ runs at right angles here into the plane of the drawing. A casting material, such as castable, curable elastomeric polymer, e.g. polyurethane, is applied via a conduit 5 through a casting nozzle 6 downward onto the radially outermost cover surface of the winding mandrel 4 or onto the starting material 20′″. Such a casting material may be chosen, for example, with respect to its pot life and viscosity such that it does not drip off the winding mandrel 4 in the course of casting. During this period, the winding mandrel 4 is rotated about its longitudinal axis in the direction of the arrow. Simultaneously with this rotation, the casting nozzle 6 is guided parallel to and along the longitudinal axis 20′ relative to the winding mandrel 4 by means of a suitable guide (not shown in detail in FIG. 3). Simultaneously with the casting application of the casting material, the starting material 20′″ is unrolled and wound on the rotating winding mandrel 4 to give windings. It is possible here for the casting material to get through the starting material 20′″ through to the winding mandrel 4. The polymer in this example, after the curing step, forms a first, preferably elastomeric polymer layer 20.1 of the press cover, which is the radially innermost here, of which FIG. 3 shows just part.

The casting material exiting from the casting nozzle 6 is a mixture of a prepolymer and a crosslinker. The former is provided from a prepolymer vessel (not shown) in which it is stored or stirred up. The reaction product may comprise an isocyanate of the invention and a polyol. It may be present in the reaction product vessel (prepolymer vessel), for example, in the form of a prepolymer of the substances just mentioned.

The crosslinker may be provided in a crosslinker vessel. The crosslinker comprises at least one first component K1 of the invention and one second component K2 of the invention. The crosslinker may also comprise a third component K3 of the invention, comprising at least one polyol, and/or a fourth component of the invention, such as a catalyst. A fifth or further components would also be conceivable in principle. The crosslinker with its corresponding components may be stirred up directly in the crosslinker vessel. It is, however, also conceivable that the apparatus comprises a corresponding individual vessel for each of the components that is connected to the crosslinker vessel in a flow-conducting manner via conduits (not shown), in order to produce the crosslinker of the invention in the crosslinker vessel.

Prepolymer vessel and crosslinker vessel are assigned to the apparatus for production of a press cover 20. They are connected via conduits (likewise not shown) in a flow-conducting manner to a mixing chamber (not shown) connected upstream of the casting nozzle 6 in flow direction. The prepolymer/crosslinker mixture is thus produced upstream of and outside the casting nozzle 6, i.e. mixed in the mixing chamber. Irrespective of the production of the mixture, this is then applied to the surface of the winding mandrel 4 to form the at least one polymer layer 20.1 of the press cover 20.

By means of such a continuous casting operation, which is also known as rotary casting, a continuous press cover 20 that forms an intrinsically closed cylinder about its longitudinal axis 20′ is thus gradually produced over the width of the winding mandrel 4, the internal circumference of which corresponds essentially to the outer circumference of the winding mandrel 4.

In principle, it would be conceivable to wind the starting material 20′″ onto more than one winding mandrel 4 shown in FIG. 3. For example, it would be possible to provide two winding mandrels that could be arranged in parallel at a distance from one another with regard to their longitudinal axes. Alternatively, it would also be conceivable to apply the polymer to the radially inner cover surface of the winding mandrel 4 as well, for example in the manner of spinning.

Irrespective of the embodiment addressed, the finished press cover 20 is finally removed from the at least one winding mandrel 4.

As shown in the figures, the press cover 20 takes the form according to the invention. This means that the single polymer layer shown therein has been produced (partly or completely) from a polyurethane. The polyurethane here has been formed from a prepolymer of the invention—which is a reaction product of at least one polyol with an isocyanate—and a crosslinker. The crosslinker comprises, for example, the components mentioned at the outset. It may also include further components known to the person skilled in the art.

By means of the invention, a particularly high stability of the press cover 20 is achieved with regard to mechanical and dynamic properties such as stability, surface hardness, resistance to pressure, temperature and hydrolysis, and low swelling, and lead in operation to a prolonged lifetime thereof. At the same time, by means of the rotary casting process described in the figures, it is possible to produce virtually bubble-free press covers that enable polymer layers of thickness up to 40 mm in one coating pass.

Although this is not shown in the figures, the reinforcing structure 20″ of the at least one polymer layer 20.1, 20.2 may also have been constructed from multiple starting materials 20′″ that have been placed one on top of another in radial direction and each run in longitudinal axis direction and in circumferential direction of the press cover 20.

1-16. (canceled)

17. A press cover, comprising:
at least one polymer layer, said polymer layer containing a polyurethane or consisting of a polyurethane;
said polyurethane having been formed from a prepolymer and a crosslinker;
said prepolymer being a reaction product of phenylene 1,4-diisocyanate and at least one polyol; and
said crosslinker including at least two components, namely,
a first component with at least one diamine; and
a second component from the group of the carbonic esters.

18. The press cover according to claim 17, wherein said first component is selected from the group consisting of 4,4′-methylenebis, 4,4′-diaminodicyclohexylmethane, and mixtures thereof.

19. The press cover according to claim 17, wherein said crosslinker contains between 25% and 95% by weight of said first component.

20. The press cover according to claim 19, wherein said crosslinker contains between 30% and 70% by weight of said first component.

21. The press cover according to claim 17, wherein said second component is or comprises propylene carbonate.

22. The press cover according to claim 17, wherein said crosslinker contains from 1% to 25% by weight of the second component.

23. The press cover according to claim 17, wherein said crosslinker further comprises a third component being a polyol.

24. The press cover according to claim 23, wherein said third component is a bifunctional polyol having a molecular weight of 1000 to 4000 g/mol.

25. The press cover according to claim 23, wherein said third component is selected from the group consisting of polyester polyol, polycaprolactone polyol, polyether polyols, polytetramethylene ether glycol, polypropylene glycol, polyethylene glycol, polyhexamethylene ether glycol, polycarbonate polyol, polyether carbonate polyol, polybutadiene polyol, perfluoropolyether polyol, silicone polyol, and mixtures thereof.

26. The press cover according to claim 23, wherein said crosslinker contains not more than 65% by weight of said third component.

27. The press cover according to claim 23, wherein said crosslinker includes a fourth component with a catalyst, and said fourth component is selected from tertiary amines, triethylamine, metal compounds, organometallic compounds, and mixtures thereof.

28. The press cover according to claim 27, wherein said fourth component is a 1,4-diazabicyclo octane, a triethylamine, a metallic or organometallic compound including or containing bismuth, mercury, aluminum, zirconium, iron, calcium, sodium, potassium, lead, tin, and/or titanium.

29. The press cover according to claim 27, wherein the crosslinker contains not more than 5% by weight of said fourth component.

30. The press cover according to claim 17, wherein said at least one polymer layer is a radially outermost polymer layer of the press cover.

31. The press cover according to claim 17, further comprising a reinforcing structure embedded into said at least one polymer layer.

32. The press cover according to claim 17, wherein said polyol in said prepolymer comprises a polyether polycarbonate polyol, a polycarbonate polyol, a polytetramethylene ether glycol, or mixtures thereof.

33. A press roll for a shoe press for treating a fibrous material web, the press roll comprising: at least one press cover according to claim 17.

34. A shoe press for treatment of a fibrous material web, the shoe press comprising: a press roll and an opposing roll disposed to form a press nip therebetween, said press roll carrying a circumferential press cover according to claim 17.

35. A method of producing a press cover, the method comprising the following steps:
a) providing at least one rotatably mounted winding mandrel;
b) providing a crosslinker with at least two components, namely, a first component containing at least one diamine and a second component from the group of the carbonic esters;
c) providing a reaction product of phenylene 1,4-diisocyanate and at least one polyol;
d) mixing the reaction product and the crosslinker to prepare a polyurethane being a reaction product-crosslinker mixture;
e) deploying the reaction product-crosslinker mixture on a surface of the winding mandrel to form at least one polymer layer of the press cover;
f) curing the at least one polymer layer; and
g) removing the press cover thus produced from the winding mandrel.

36. The method according to claim 35, which further comprises introducing of a reinforcing structure into the reaction product-crosslinker mixture before or after step e).
